(19) United States
(12) Patent Application Publication
(10) Pub. No.: US 2025/0307988 A1
(43) Pub. Date: Oct. 2, 2025

(54) METHOD OF DISPLAYING CORRECTED IMAGE OF SURVEYING DEVICE, SURVEYING DEVICE, AND METHOD OF DETERMINING TARGET LIGHT POSITION FOR AUTOMATIC COLLIMATION OR AUTOMATIC TRACKING OF SURVEYING DEVICE

(71) Applicant: TOPCON CORPORATION, Tokyo (JP)

(72) Inventor: Nobuyuki NISHITA, Tokyo (JP)

(73) Assignee: TOPCON CORPORATION, Tokyo (JP)

(21) Appl. No.: 19/090,840

(22) Filed: Mar. 26, 2025

(30) Foreign Application Priority Data
Mar. 27, 2024 (JP) 2024-052165

(51) Int. Cl. G06T 3/60; G01B 21/22; G01S 17/08; G01S 17/86

(52) U.S. Cl. CPC G06T 3/60; G01B 21/22; G01S 17/08; G01S 17/86

(57) ABSTRACT

A technique of the present disclosure includes: capturing a first image when a scanning mirror is in a first position; rotating the scanning mirror by a first angle from the first position to a second position in a rotational direction of a rotation shaft; capturing a second image at the second position; obtaining rotation center coordinates of the second image with respect to the first image using the first image, the second image, and the first angle measured by an angle measuring sensor, and generating a corrected image, in which rotation of the second image and displacement about the rotation shaft are corrected, based on the rotation center coordinates, the first angle, and the second image.

### CROSS-REFERENCE TO RELATED APPLICATIONS

This application claims the benefit of priority under 35 U.S.C. 119 from Japanese Patent Application No. 2024-052165, filed Mar. 27, 2024; the disclosure of which is incorporated herein by reference in its entirety.

### BACKGROUND

The present disclosure relates to a method of displaying corrected images of the surveying device, the surveying device, and a method of determining the target light position for automatic collimation or automatic tracking of the surveying device.

Japanese Unexamined Patent Publication No. 2022-23609 discusses a surveying device including a light receiving element that receives reflected distance measuring light from a measurement object, a tracking light receiving element that receives tracking light emitted to and reflected from the measurement object, and an imaging unit that receives background light, where the distance measuring light, tracking light, and background light are coaxial.

### SUMMARY

The surveying device where the distance measuring light, the tracking light, and the background light are coaxial has a reflecting mirror on its optical axis and rotates about a rotational axis when the optical axis for collimation is rotated up and down in the vertical direction. This rotation of the reflecting mirror causes rotation and displacement of an image reflected on its reflection surface. Since the imaging element is fixed within the surveying device, the two-dimensional image captured by the imaging element also undergoes rotation and displacement.

Further, tracking by the surveying device uses a target position obtained as the difference between a light-emitting image and a non-light-emitting image. This requires correction of displacement of the captured image caused by the rotation and movement thereof.

Accordingly, an object of the present disclosure is to enable accurate tracking even in a surveying device having a reflecting mirror that rotates about an optical axis of an imaging element.

To achieve the object described above, a method of the present disclosure, of displaying a corrected image in a surveying device uses the surveying device including: an imaging unit having an imaging element configured to capture an image; a scanning mirror configured to rotate about a rotation shaft in one of a horizontal direction or a vertical direction, and having a flat reflection surface inclined relative to the rotation shaft; an angle measuring sensor configured to measure a rotation angle of the rotation shaft; a controller; and a support frame having therein the imaging unit that is fixed inside the support frame and that does not rotate about the rotation shaft, the scanning mirror, the angle measuring sensor, and the controller, and to display the image captured by the imaging unit on a display of the surveying device or a display of a mobile terminal, the method includes: first imaging of capturing, by the imaging unit, a first image when the scanning mirror is in a first position; rotating, by the controller, the scanning mirror by a first angle from the first position to a second position in a rotational direction of the rotation shaft; second imaging of capturing, by the imaging unit, a second image at the second position; image correcting of generating, by the controller, a corrected image, in which rotation of the second image and displacement about the rotation shaft are corrected, based on rotation center coordinates, the first angle, and the second image; and corrected image displaying of displaying, by the controller, the corrected image, instead of the second image, on the display of the surveying device or the display of the mobile terminal.

To achieve the object described above, a surveying device of the present disclosure includes: an imaging unit having an imaging element configured to capture an image; a scanning mirror configured to rotate about a rotation shaft in one of a horizontal direction or a vertical direction, and having a flat reflection surface inclined relative to the rotation shaft; an angle measuring sensor configured to measure a rotation angle of the rotation shaft; a controller; and a support frame having therein the imaging unit, the scanning mirror, the angle measuring sensor, and the controller, the imaging unit is fixed inside the support frame and does not rotate about the rotation shaft, and to display the image captured by the imaging unit on a display of the surveying device or a display of a mobile terminal, the imaging unit captures a first image when the scanning mirror is in a first position, the controller rotates the scanning mirror by a first angle from the first position to a second position in a rotational direction of the rotation shaft, the imaging unit captures a second image at the second position, the controller generates a corrected image, in which rotation of the second image and displacement about the rotation shaft are corrected, based on rotation center coordinates, the first angle, and the second image, and the controller displays the corrected image, instead of the second image, on the display of the surveying device or the display of the mobile terminal.

To achieve the above-described object, a method of determining a target light position for automatic collimation or automatic tracking by a surveying device, uses: the surveying device including an imaging unit having an imaging element configured to capture an image, a scanning mirror configured to rotate about a rotation shaft in one of a horizontal direction or a vertical direction, and having a flat reflection surface inclined relative to the rotation shaft; an angle measuring sensor configured to measure a rotation angle of the rotation shaft; a controller; and a support frame having therein the imaging unit that is fixed inside the support frame and that does not rotate about the rotation shaft, the scanning mirror, the angle measuring sensor, and the controller; and a target capable of emitting light and ceasing light emission, and the method includes: first imaging of capturing, by the imaging unit, a first image when the scanning mirror is in a first position while the target is in a first state of either emitting light or ceasing light emission; rotating, by the controller, the scanning mirror by a first angle from the first position to a second position in a rotational direction of the rotation shaft; second imaging of capturing, by the imaging unit, a second image in the second position while the target is in a second state which is different from the first state of either emitting light or ceasing light emission; image correcting of generating, by the controller, a corrected image, in which rotation of the second image and displacement about the rotation shaft are corrected, based on rotation center coordinates, the first angle, and the second image; and target position determining of, by the controller, obtaining a differential image between the first image and the corrected image and determining the target light position by using the differential image.

To achieve the object described above, a surveying device of the present disclosure is a surveying device capable of automatic collimation or automatic tracking of a target light position, the surveying device including: an imaging unit having an imaging element configured to capture an image; a scanning mirror configured to rotate about a rotation shaft in one of a horizontal direction or a vertical direction, and having a flat reflection surface inclined relative to the rotation shaft; an angle measuring sensor configured to measure a rotation angle of the rotation shaft; a controller; and a support frame having therein the imaging unit that is fixed inside the support frame and that does not rotate about the rotation shaft, the scanning mirror, the angle measuring sensor, and the controller, the surveying device uses a target capable of emitting light and ceasing light emission; the imaging unit captures a first image when the scanning mirror is in a first position while the target is in a first state of either emitting light or ceasing light emission; the controller rotates the scanning mirror by a first angle from the first position to a second position in a rotational direction of the rotation shaft; the imaging unit captures a second image in a second position while the target is in a second state which is different from the first state of either emitting light or ceasing light emission; the controller generates a corrected image, in which rotation and displacement of the second image are corrected, based on rotation center coordinates, the first angle, and the second image; and the controller obtains a differential image between the first image and the corrected image and determines the target light position by using the differential image.

### BRIEF DESCRIPTION OF THE DRAWINGS

FIG. 1 is a schematic sectional view of a surveying device, according to the present disclosure.

FIG. 2 is a diagram showing a distance measuring unit in the surveying device, according to the present disclosure.

FIG. 3 is a side view of a beam-splitter surface of a multilayer film optical element.

FIG. 4 is a diagram for explaining a case with no rotation of an imaging surface.

FIG. 5 is a diagram for explaining a case with rotation of an imaging surface.

FIG. 6 is a diagram for explaining an exemplary calibration method, according to an embodiment of the present disclosure.

FIG. 7 is a functional block diagram of a surveying device, according to the present disclosure.

FIG. 8 is a flowchart showing a flow of steps in the calibration method, according to the present disclosure.

FIG. 9 is a diagram for explaining an exemplary calibration method, according to an embodiment of the present disclosure.

FIG. 10 is a flowchart showing a flow of steps in the calibration method, according to the present disclosure.

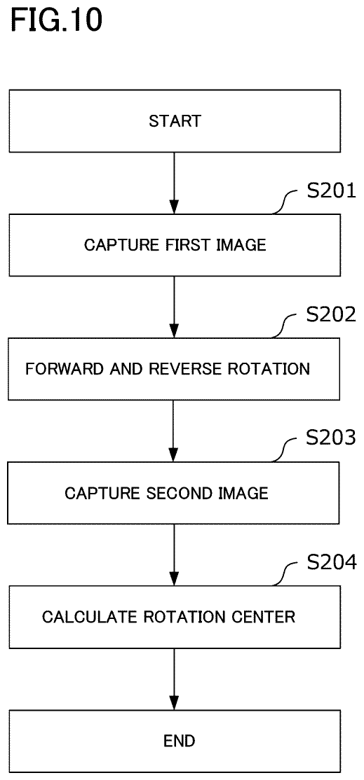

FIG. 11 is a flowchart showing a flow of steps in an image correction method, according to the present disclosure.

FIG. 12 is a schematic diagram for explaining how a target light position is determined.

FIG. 13 is a flowchart showing a flow of steps in a method of determining the target light position, according to the present disclosure.

### DETAILED DESCRIPTION

Embodiments of the present disclosure will be described below with reference to the drawings. While the following description uses a laser scanner as an example for explanatory purposes, the present disclosure is also applicable to various other surveying devices. Further, since the basic exemplary hardware configuration is similar to that of the traditional example, the reader may refer to <Rotation and Movement of Captured Image> and thereafter to understand the further distinctive configurations of the present disclosure. Note, however, that the hardware configuration of the surveying device is also a part of an important characteristic of the present disclosure.

### Exemplary Hardware Configuration of Surveying Device

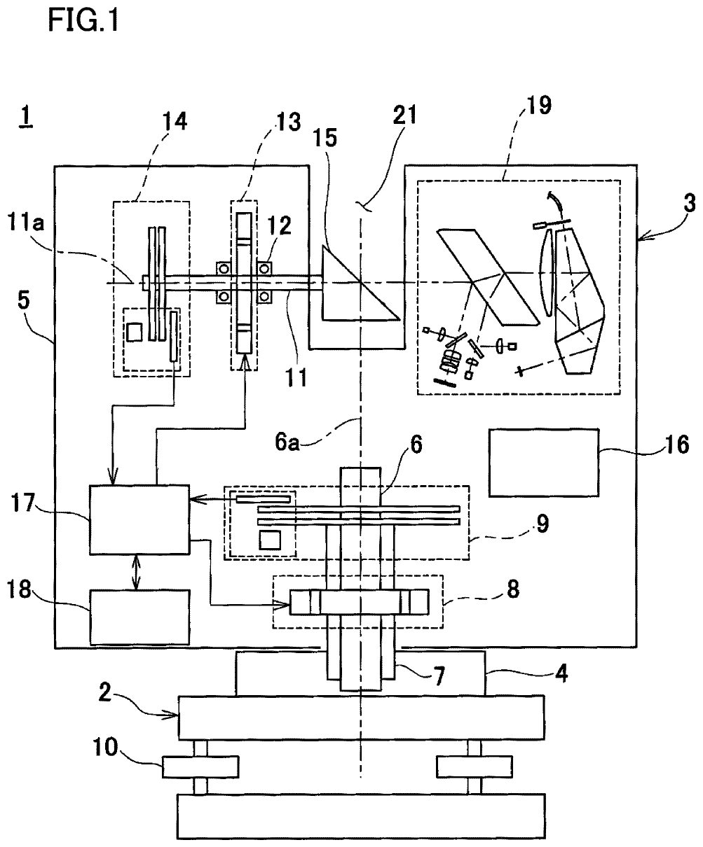

FIG. 1 is a schematic sectional view of a surveying device, according to the present disclosure. The surveying device 1 is, for example, a laser scanner and includes a leveling unit 2 configured to be attached to a tripod (not shown) and a surveying device main body 3 attached to the leveling unit 2. The surveying device 1 is capable of performing both prism measurement and non-prism measurement.

The surveying device main body 3 includes a fixture 4, a support frame 5, a horizontal rotation shaft 6 (second rotation shaft), a horizontal rotation bearing 7, a horizontal rotation motor 8 configured to serve as a horizontal rotation driving unit, a horizontal angle encoder 9 configured to serve as a horizontal angle detector, a vertical rotation shaft 11 (first rotation shaft), a vertical rotation bearing 12, a vertical rotation motor 13 configured to serve as a vertical rotation driving unit, a vertical angle encoder 14 configured to serve as a vertical angle detector, a scanning mirror 15 configured to serve as a vertical rotation unit, an operation panel 16 configured to serve as an operation unit and a display, a controller 17, a storage 18, a distance measuring unit 19, and the like. The controller 17 includes a CPU specifically designed for this device or a general-purpose CPU and has arithmetic functions and is capable of processing information by using an application program stored in the storage 18 or in a memory. The horizontal angle encoder 9 and the vertical angle encoder 14 are collectively referred to as an angle measuring sensor.

The horizontal rotation bearing 7 is fixed to the fixture 4. The horizontal rotation shaft 6 has a vertically oriented axis 6a and is rotatably supported by the horizontal rotation bearing 7. The support frame 5 is supported by the horizontal rotation shaft 6 and is arranged to rotate integrally with the horizontal rotation shaft 6 in a horizontal direction.

Between the horizontal rotation bearing 7 and the support frame 5, a horizontal rotation motor 8 is arranged. This horizontal rotation motor 8 is controlled by the controller 17. The controller 17 rotates the support frame 5 about the axis 6a by using the horizontal rotation motor 8.

The horizontal angle encoder 9 detects a relative rotation angle of the support frame 5 with respect to the fixture 4. The controller 17 takes the detection signal from the horizontal angle encoder 9 as an input to calculate the horizontal angle data. The controller 17 performs feedback control for the horizontal rotation motor 8 based on the horizontal angle data.

The support frame 5 has the vertical rotation shaft 11 whose axis 11a is horizontal. The vertical rotation shaft 11 is rotatable via the vertical rotation bearing 12. An intersection of the axis 6a and the axis 11a is the point of emission of the distance measuring light and serves as the origin of the coordinate system of the surveying device main body 3.

The support frame 5 has a recess 21. The vertical rotation shaft 11 extends into the recess 21 at one end, and to this one end, the scanning mirror 15 is fixed and accommodated in the recess 21.

To the other end of the vertical rotation shaft 11, the vertical angle encoder 14 is arranged. The vertical rotation motor 13 is provided on the vertical rotation shaft 11, and the vertical rotation motor 13 is controlled by the controller 17. The controller 17 rotates the vertical rotation shaft 11 via the vertical rotation motor 13, thus rotating the scanning mirror 15 about the axis 11a.

The vertical angle encoder 14 detects the rotation angle of the scanning mirror 15 and its detection signal is input to the controller 17. Based on the detection signal, the controller 17 calculates vertical angle data of the scanning mirror 15 and performs feedback control for the vertical rotation motor 13 based on the vertical angle data.

Further, the horizontal angle data, the vertical angle data, the measurement results, measurement point intervals, measurement angle intervals calculated by the controller 17 are stored in the storage 18. The storage 18 may be of various types of storage, such as an HDD as a magnetic storage device, CDs, DVDs as an optical storage device, RAM, ROM, and DRAM as a semiconductor storage device, a memory card, a USB memory, and the like. The storage 18 may be detachable from the support frame 5 or may be capable of sending data to an external storage device or an external data processing device via a communication unit (not shown).

The storage 18 stores various programs such as a sequence program that controls a distance measuring operation, a calculation program that calculates a distance through the distance measuring operation, a calculation program that calculates an angle based on the horizontal angle data and the vertical angle data, a calculation program that calculates the 3D coordinates of a desirable measurement point based on the distance and the angle, a tracking program for tracking a measurement object, a setting program for setting intervals of measurement points and intervals of measurement angles, a control program for controlling the drive of a light intensity adjustment member, a calibration program that uses the rotation center. The controller 17 executes various programs to perform various processes.

The operation panel 16 is, for example, a touch panel and serves as both an operation unit for instructing distance measurement and setting measurement conditions, and a display for displaying measurement results and the like.

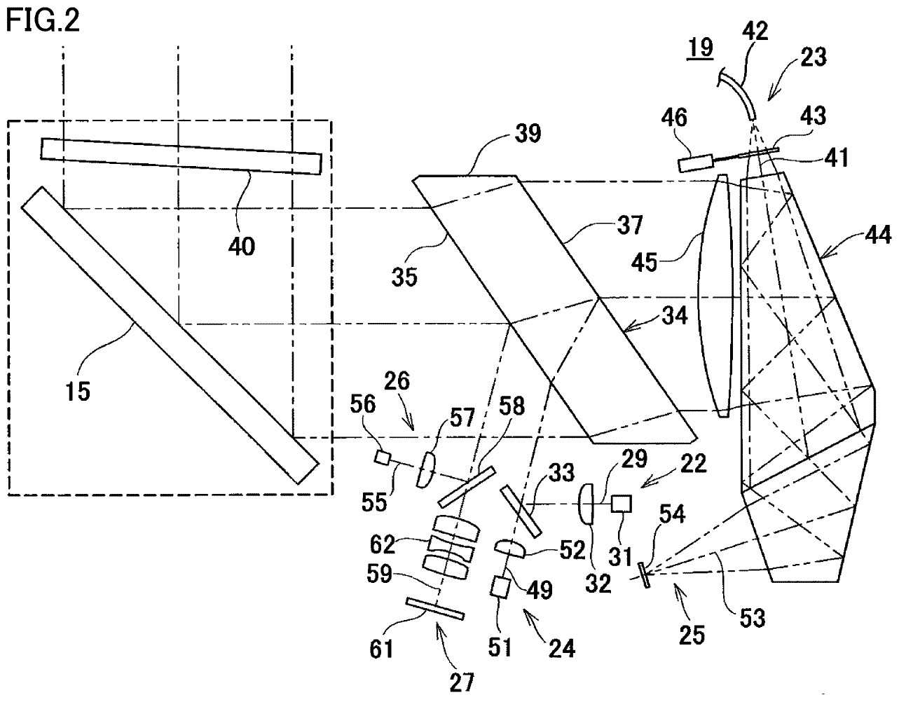

Next, the distance measuring unit 19 will be described with reference to FIG. 2.

The distance measuring unit 19 essentially includes a distance measuring light emitter 22, a distance measuring light receiver 23, a tracking light emitter 24, a tracking light receiver 25, a laser-pointer light emitter 26, and an imaging unit 27. The distance measuring light emitter 22 and the distance measuring light receiver 23 constitute the distance measurement unit. The tracking light emitter 24 and the tracking light receiver 25 constitute a tracking unit.

The distance measuring light emitter 22 has an emitting optical axis 29. Further, the distance measuring light emitter 22 has a light emitting element 31, such as a laser diode (LD), a projection lens 32, and a beam combiner 33 serving as a first deflection optical component, which are provided on the emitting optical axis 29, as well as a multilayer film optical element 34 serving as a second deflection optical component provided on a reflected optical axis of the emitting optical axis 29, which is reflected by the beam combiner 33. Further, the scanning mirror 15 is provided on the reflected optical axis of the emitting optical axis, which is reflected by the multilayer film optical element 34.

Note that the projection lens 32, the beam combiner 33, and the multilayer film optical element 34 constitute a distance measuring light projection optical system. Further, in this example, the emitting optical axis 29, the reflected optical axis of the emitting optical axis 29, which is reflected by the beam combiner 33 and the reflected optical axis of the emitting optical axis 29, which is reflected by the multilayer film optical element 34 are collectively referred to as emitting optical axis 29.

The light emitting element 31 emits pulses of a laser beam (invisible light) of an infrared or near-infrared wavelength as a distance measuring light or emits bursts of a laser beam as a distance measuring light.

The beam combiner 33 has an optical characteristic of transmitting light of a specific wavelength and reflecting light of another specific wavelength so that the light of the other specific wavelength is coaxial with the transmitted light. The beam combiner 33 transmits the tracking light and reflects the distance measuring light emitted from the light emitting element 31 so that the distance measuring light is coaxial with the tracking light. That is, the beam combiner 33 is positioned on a common optical path of the distance measuring light and the tracking light. The beam combiner 33 may be configured to reflect the tracking light and transmit the distance measuring light.

The multilayer film optical element 34 is, for example, a glass plate having a predetermined thickness and is inclined relative to the emitting optical axis 29. One surface (first incident surface) of the multilayer film optical element 34, which is close to the light emitting element 31, serves as a long-pass filter surface 35, on which a long-pass filter film that transmits infrared or near-infrared light and reflects visible light is deposited.

Another surface (second incident surface) of the multilayer film optical element 34, which is far from the light emitting element 31, serves as a beam-splitter surface 37, on which a beam-splitter film 36 is deposited.

Note that the thickness and inclination angle of the multilayer film optical element 34 are set to allow the distance measuring light emitter 22 (tracking light emitter 24) and the laser-pointer light emitter 26 (imaging unit 27) to be separated from each other while maintaining a predetermined inter-optical axis distance between the emitting optical axis 29 (tracking light optical axis 49) and the laser-pointer optical axis 55 (imaging optical axis 59). The multilayer film optical element 34 also functions as an optical axis separation optical member that separates the emitting optical axis 29 (tracking light optical axis 49) and the laser-pointer optical axis 55 (imaging optical axis 59).

The distance measuring light receiver 23 has a light reception optical axis 41. Further, the distance measuring light receiver 23 has a light receiver 42, such as an optical fiber, a light intensity adjustment member 43, and a light receiving prism 44, which are provided on the light reception optical axis 41, as well as an imaging lens 45 and the multilayer film optical element 34, both of which are provided on a reflected optical axis of the light reception optical axis 41 reflected by the light receiving prism 44. Note that the light intensity adjustment member 43, the light receiving prism 44, the imaging lens 45, and the multilayer film optical element 34 constitute a distance measuring light receiving optical system. Further, in this example, the light reception optical axis 41 and the reflected optical axis of the light reception optical axis 41, which is reflected by the light receiving prism 44, are collectively referred to as the light reception optical axis 41.

The light receiver 42 is, for example, a light receiving end surface of the optical fiber and receives the distance measuring light as the reflected distance measuring light reflected by the measurement object. Further, the optical fiber guides the reflected distance measuring light to the light receiving element arranged in a predetermined position, so that the reflected distance measuring light is received by the light receiving element. The light receiving element may be arranged at the light receiving position of the light receiver 42. The light receiver 42 is hereinafter referred to as the light receiving element 42.

The light intensity adjustment member 43 is, for example, a parallel flat plate made of glass having a known thickness and is positioned orthogonally to the light reception optical axis 41. The light intensity adjustment member 43 can be inserted into and removed from the light reception optical axis 41 by a driving mechanism 46 such as a solenoid.

Although illustration is omitted, the light intensity adjustment member 43 has a light intensity adjustment surface 47 at the center portion of its incident surface for the reflected distance measuring light. This light intensity adjustment surface 47 is formed by, for example, deposition of a reflection film. In the remaining part other than the light intensity adjustment surface 47, a fully transmissive surface 48 is formed by depositing an anti-reflection film.

Note that a window part 40 that rotates integrally with the scanning mirror 15 is provided on the optical axis of the distance measuring light reflected by the scanning mirror 15. The window part 40 is inclined by a predetermined angle relative to the optical axis (emitting optical axis 29) of the distance measuring light and keeps the distance measuring light (stray light) reflected by the window part 40 from entering the light receiving element 42.

The tracking light emitter 24 has a tracking light optical axis 49. Further, the tracking light emitter 24 has a tracking light emitting element 51, a projection lens 52, the beam combiner 33, and the multilayer film optical element 34, which are provided on the tracking light optical axis 49. Note that the projection lens 52, the beam combiner 33, and the multilayer film optical element 34 constitute a tracking light projection optical system. Further, in this example, the tracking light optical axis 49 and the reflected optical axis of the tracking light optical axis 49, which is reflected by the multilayer film optical element 34, are collectively referred to as the tracking light optical axis 49.

The tracking light emitting element 51 is, for example, a laser diode (LD), and is configured to emit, as tracking light, a laser beam (invisible light) of an infrared or near-infrared wavelength different from the wavelength of the distance measuring light.

The tracking light receiver 25 has a tracking light reception optical axis 53. Further, the tracking light receiver 25 has a tracking light receiving element 54 and the light receiving prism 44, which are provided on the tracking light reception optical axis 53, as well as the imaging lens 45 and the multilayer film optical element 34, both of which are provided on the reflected optical axis of the tracking light reception optical axis 53 reflected by the light receiving prism 44. Note that the light receiving prism 44, the imaging lens 45, and the multilayer film optical element 34 constitute a tracking light receiving optical system. Further, in this example, the tracking light reception optical axis 53 and the reflected optical axis of the tracking light reception optical axis 53, which is reflected by the light receiving prism 44, are collectively referred to as the tracking light reception optical axis 53.

The tracking light receiving element 54 is configured as a light receiving element that receives the tracking light reflected by the measurement object as a reflected tracking light. The tracking light receiving element 54 is a CCD or a CMOS, which is a collection of pixels, and the position of each pixel in the picture element can be identified. For example, each pixel has pixel coordinates with the center of the tracking light receiving element 54 as the origin, and the position of each pixel in the picture element is identified based on the pixel coordinates. Each pixel outputs the pixel coordinates to the controller 17 together with a received optical signal.

The laser-pointer light emitter 26 has a laser-pointer optical axis 55. Further, the laser-pointer light emitter 26 has a light emitting element 56, a projection lens 57, and a beam-splitter 58 serving as a third deflection optical component, which are provided on the laser-pointer optical axis 55, as well as a multilayer film optical element 34 provided on the reflected optical axis of the laser-pointer optical axis 55, which is reflected by the beam-splitter 58. Further, the laser-pointer light is deflected by the long-pass filter surface 35 to be coaxial with the distance measuring light and the tracking light. That is, the multilayer film optical element 34 is positioned in a common optical path of the distance measuring light, the tracking light, the laser-pointer light, and the visible light.

Note that the projection lens 57, the beam-splitter 58, and the multilayer film optical element 34 constitute a laser-pointer projection optical system. Further, the laser-pointer optical axis 55, the reflected optical axis of the laser-pointer optical axis 55, which is reflected by the beam-splitter 58, and the reflected optical axis of the laser-pointer optical axis 55, which is reflected by the multilayer film optical element 34, are collectively referred to as the laser-pointer optical axis 55. For example, the laser-pointer optical axis 55 reflected by the beam-splitter 58 is parallel to the tracking light optical axis 49.

The light emitting element 56 is, for example, a laser diode (LD), and is configured to emit visible light such as red light as a laser-pointer light. Further, the beam-splitter 58 has an optical characteristic of transmitting light with a predetermined transmittance while reflecting light with a predetermined reflectance and deflects the laser-pointer light to be coaxial with the visible light. That is, the beam-splitter 58 is positioned in a common optical path of the laser-pointer light and the visible light.

The imaging unit 27 has the imaging optical axis 59. Further, the imaging unit 27 has an imaging element 61, a camera lens group 62 including a plurality of lenses, a beam-splitter 58, and the multilayer film optical element 34, which are provided on the imaging optical axis 59. Note that the camera lens group 62, the beam-splitter 58, and the multilayer film optical element 34 constitute an imaging optical system. Further, the imaging optical axis 59 and the reflected optical axis of the imaging optical axis 59, which is reflected by the multilayer film optical element 34, are collectively referred to as the imaging optical axis 59.

The imaging element 61 is a CCD or a CMOS, which is a collection of pixels, and the position of each pixel in the picture element can be identified. For example, each pixel has pixel coordinates with the center of the imaging element 61 as the origin, and the position of each pixel in the picture element is identified based on the pixel coordinates. Each pixel outputs the pixel coordinates to the controller 17 together with a received optical signal.

Note that the positions of the laser-pointer light emitter 26 and the imaging unit 27 are set so that the transmission position of the emitting optical axis 29 or the tracking light optical axis 49 from the long-pass filter surface 35 matches the reflection positions of the laser-pointer optical axis 55 and the imaging optical axis 59 with respect to the long-pass filter surface 35.

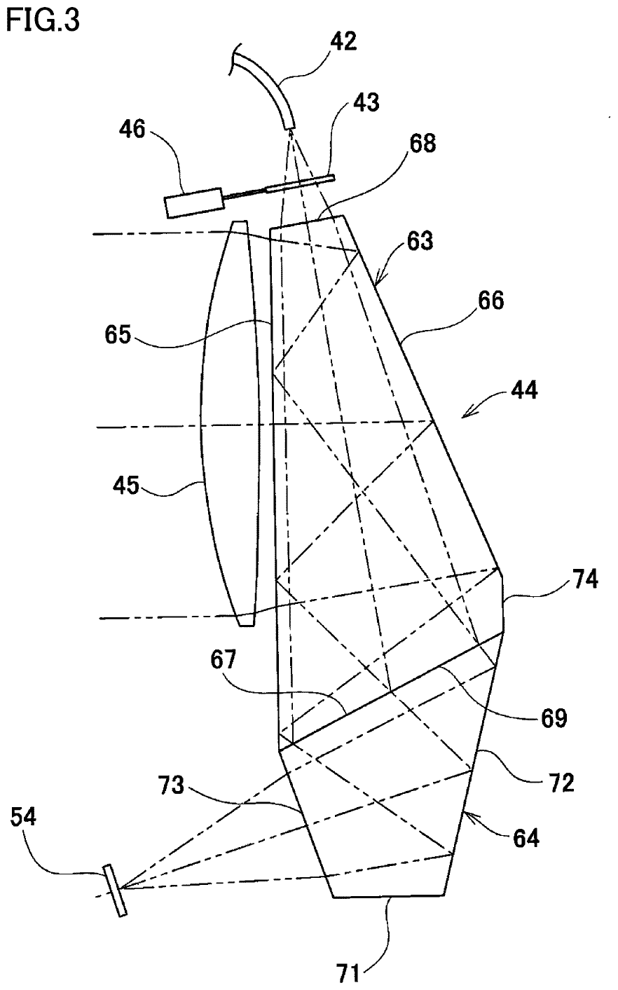

Next, the details of the light receiving prism 44 will be described with reference to FIG. 3.

The light receiving prism 44 is formed by integrating a first prism 63 and a second prism 64 into a single structure. The first prism 63 is a pentagonal dichroic prism having a predetermined refractive index, and the second prism 64 is a rectangular dichroic prism having a predetermined refractive index.

The first prism 63 has a first surface 65 opposing the imaging lens 45, a second surface 66 opposing the first surface 65, a third surface 67 positioned on the lower side of the sheet of FIG. 3, and a fourth surface 68 positioned on the upper side of the sheet of FIG. 3.

Further, the second prism 64 has a fifth surface 69 in contact with the third surface 67, a sixth surface 71 opposing the fifth surface 69, a seventh surface 72 positioned on the right side of the sheet of FIG. 3, and an eighth surface 73 positioned on the left side of the sheet of FIG. 3.

The first prism 63 and the second prism 64 are integrated into a single structure through the third surface 67 and the fifth surface 69. Further, a corner formed by the second surface 66 and the third surface 67 of the first prism 63 is chamfered, forming a chamfered part 74. This chamfered part 74 makes the first prism 63 a pentagonal prism. Further, with the chamfered part 74, the areas of the third surface 67 and the fifth surface 69 match, thus forming a flush light receiving prism 44 with the first prism 63 and the second prism 64.

The surface (incident surface) of the first surface 65 is a fully transmissive surface having thereon an anti-reflection film. Further, the first surface 65 is perpendicular to the light reception optical axis 41 and the tracking light reception optical axis 53, and the incident angle of each optical axis with respect to the first surface 65 is 0°.

The second surface 66 has a reflection film. Further, the second surface 66 is inclined at a predetermined angle relative to the light reception optical axis 41 and the tracking light reception optical axis 53, and is configured to reflect the reflected distance measuring light and the reflected tracking light having passed the first surface 65 towards the first surface 65, so that these rays of light are incident on the first surface 65 at an incident angle equal to or greater than the critical angle. Note that an angle of the optical axis relative to a surface means the angle between the normal line of the surface and the optical axis.

Further, the third surface 67 is inclined at a predetermined angle relative to the light reception optical axis 41 and the tracking light reception optical axis 53 reflected by the first surface 65. Further, a dichroic filter film is provided on the third surface 67 or in the boundary surface between the third surface 67 and the fifth surface 69. The dichroic filter film is configured to reflect the reflected distance measuring light while transmitting the reflected tracking light. That is, the third surface 67 or the boundary surface between the third surface 67 and the fifth surface 69 serves as a splitting surface that splits the reflected distance measuring light and the reflected tracking light. Note that the dichroic filter film may be configured to transmit the reflected distance measuring light and reflect the reflected tracking light.

The fourth surface 68 is a fully transmissive surface with an anti-reflection film and is configured to fully transmit the reflected distance measuring light reflected by the third surface 67. Further, the fourth surface 68 is orthogonal to the light reception optical axis 41, and the incident angle of the light reception optical axis 41 with respect to the fourth surface 68 is 0°.

The seventh surface 72 has a reflection surface. Further, the seventh surface 72 is inclined at a predetermined angle relative to the tracking light reception optical axis 53. For example, the seventh surface 72 is configured so that the reflected tracking light having passed through the third surface 67 or the boundary surface between the third surface 67 and the fifth surface 69 is incident on the seventh surface 72 at an incident angle equal to or greater than the critical angle and reflected towards the eighth surface 73.

The eighth surface 73 is a fully transmissive surface with an anti-reflection film and is configured to fully transmit the reflected tracking light reflected by the seventh surface 72. Further, the eighth surface 73 is orthogonal to the tracking light reception optical axis 53, and the incident angle of the tracking light reception optical axis 53 with respect to the eighth surface 73 is 0°. Note that the sixth surface 71 does not have the reflection film and the like, because the reflected tracking light is not incident thereon.

Next, a case of performing measurement and tracking by using the surveying device 1 having the distance measuring unit 19 will be described. Note that the following description deals with a case of measuring a movable measurement object such as a prism. Further, various operations by the distance measuring unit 19 are performed by the controller 17 executing various programs.

The distance measuring unit 19 is controlled by the controller 17. The light emitting element 31 emits a laser beam having a red or near-infrared wavelength as distance measuring light, and the distance measuring light emitted enters the beam combiner 33 via the projection lens 32. The distance measuring light reflected by the beam combiner 33 passes through the long-pass filter surface 35 of the multilayer film optical element 34, is reflected by the beam-splitter film 36 on the beam-splitter surface 37, and then passes through the long-pass filter surface 35 again. The distance measuring light is deflected during the process of passing through the long-pass filter surface 35. The distance measuring light that has passed through the long-pass filter surface 35 is orthogonally deflected by the scanning mirror 15 and is emitted toward a predetermined measurement object through the window part 40.

Note that the optical axis of the distance measuring light (emitting optical axis 29) emitted from the scanning mirror 15 matches the axis 11a. Rotation of the scanning mirror 15 about the axis 11a causes the distance measuring light to be rotated (scanned) in a plane that is orthogonal to the axis 11a and includes the axis 6a.

The distance measuring light (reflected distance measuring light) reflected by the measurement object enters the scanning mirror 15 through the window part 40 and is orthogonally reflected by the scanning mirror 15. The reflected distance measuring light, after passing through the multilayer film optical element 34, is focused by the imaging lens 45 while entering the light receiving prism 44.

The reflected distance measuring light that has passed through the first surface 65 undergoes successive internal reflection at the second surface 66, the first surface 65, and the third surface 67 (or the boundary surface between the third surface 67 and the fifth surface 69), and then enters the fourth surface 68 at an incident angle of 0°. Further, the reflected distance measuring light that has entered the fourth surface 68 passes through the fourth surface 68 and is received by the light receiving element 42 via the light intensity adjustment member 43.

Since the reflected distance measuring light reflected by the second surface 66 enters the first surface 65 at an incident angle equal to or greater than the critical angle, the reflected distance measuring light undergoes total internal reflection at the first surface 65. Further, in this configuration, the reflected distance measuring light that is internally reflected in the light receiving prism 44 does not interfere with the chamfered part 74. That is, the chamfered part 74 is formed outside the optical path of the reflected distance measuring light.

The plate thickness of the light intensity adjustment member 43 is known. Therefore, the extension of the optical path length of the reflected distance measuring light caused by the insertion of the light intensity adjustment member 43 can be easily corrected by subtracting an offset value, which is based on the plate thickness, from the measurement result.

The controller 17 executes distance measurement for each pulse of the distance measuring light (Time of Flight), based on the difference between the timing of emitting light from the light emitting element 31 and the timing of receiving light at the light receiving element 42 (i.e., the round-trip time of the pulse light) and the speed of light. The timing of light emission, i.e., the pulse intervals, repetition frequency of the light emission, and peak power of the pulses of the light emitting element 31 can be changed.

The support frame 5 and the scanning mirror 15 rotate at a constant speed, and two-dimensional scanning using the distance measuring light is performed through the cooperation of the vertical rotation of the scanning mirror 15 and the horizontal rotation of the support frame 5. Further, distance measurement data (slope distance) is obtained by measuring the distance with each pulse of light, and vertical angle data and horizontal angle data can be obtained by detecting the vertical and horizontal angles using the vertical angle encoder 14 and the horizontal angle encoder 9, respectively, for each pulse of light. With the vertical angle data, the horizontal angle data, and the distance measurement data, 3D coordinates for the measurement object can be calculated. Further, by rotating the scanning mirror 15 to irradiate the distance measuring light while rotating, three-dimensional point cloud data can be obtained.

Here, the reflected distance measuring light reflected by the measurement object has a higher light intensity in the central region when a short distance is measured and a higher light intensity in the peripheral region when a long distance is measured. Therefore, the dimming effect of the light intensity adjustment surface 47 mainly acts on the reflected distance measuring light when a short distance is measured.

Further, in parallel with the above-described distance measuring operation, the tracking light emitting element 51 emits, as the tracking light, infrared light or a laser beam of a near-infrared wavelength, both of which are invisible light and have a wavelength different from that of the distance measuring light. The tracking light emitted enters the beam combiner 33 via the projection lens 52. The tracking light passed through the beam combiner 33 passes through the long-pass filter surface 35 coaxially with the distance measuring light, is reflected by the beam-splitter film 36 on the beam-splitter surface 37, and then passes through the long-pass filter surface 35 again. Furthermore, the tracking light is also deflected during the process of passing through the long-pass filter surface 35, as in the case of the distance measuring light. The tracking light that has passed through the long-pass filter surface 35 is orthogonally deflected by the scanning mirror 15 and is emitted toward a predetermined measurement object through the window part 40.

The reflected tracking light, which is reflected by the measurement object, is reflected by the scanning mirror 15, and after passing through the multilayer film optical element 34 while being deflected, the light is focused by the imaging lens 45 and enters the light receiving prism 44.

The reflected tracking light that has passed through the first surface 65 undergoes successive internal reflection at the second surface 66 and the first surface 65, and then passes through the third surface 67 (or the boundary surface between the third surface 67 and the fifth surface 69). The reflected tracking light that has passed through the third surface 67 undergoes internal reflection at the seventh surface 72, and then passes through the eighth surface 73 at an incident angle of 0° and is received by the tracking light receiving element 54.

The reflected tracking light reflected by the second surface 66 enters the first surface 65 at an incident angle equal to or greater than the critical angle, and the reflected tracking light that has passed through the third surface 67 (or the boundary surface between the third surface 67 and the fifth surface 69) is reflected by the seventh surface 72 at an incident angle equal to or greater than the critical angle and enters the eighth surface 73. Therefore, the reflected tracking light undergoes total internal reflection at the first surface 65 and the seventh surface 72.

The controller 17 calculates the deviation between the center of the tracking light receiving element 54 and the incident position of the reflected tracking light, and based on this deviation, controls the horizontal rotation motor 8 and the vertical rotation motor 13 so that the incident position of the reflected tracking light coincides with the center of the tracking light receiving element 54. This way, the surveying device main body 3 tracks the measurement object.

Further, in parallel with the above-described distance measuring operation and tracking operation, the light emitting element 56 emits, as the laser-pointer light, a laser beam having a wavelength in the visible light region, such as a red laser beam. The laser-pointer light emitted enters the beam-splitter 58 via the projection lens 57. The laser-pointer light reflected by the beam-splitter 58 is reflected by the long-pass filter surface 35 of the multilayer film optical element 34 so as to be coaxial with the distance measuring light and the tracking light. The laser-pointer light reflected by the long-pass filter surface 35 is orthogonally deflected by the scanning mirror and is emitted toward the measurement object through the window part 40. Since the laser-pointer light is coaxial with the distance measuring light, the position to which the distance measuring light is emitted coincides with that of the laser-pointer light.

The laser-pointer light (reflected laser-pointer light) reflected by the measurement object enters the distance measuring unit 19 coaxially with the reflected distance measuring light, reflected tracking light, and visible light (background light). The reflected laser-pointer light and visible light are reflected by the long-pass filter surface 35 and enter the imaging element 61 through the beam-splitter 58 and the camera lens group 62.

With the reflected laser-pointer light and the visible light entering the imaging element 61, the controller 17 can obtain an image centered on the reflected laser-pointer light, i.e., an image centered on the distance measuring light. Note that the image obtained here can be used for specifying the measurement object and collimation. Further, an image with only the background light may be obtained without activating the light emitting element 56.

As described above, the tracking light receiving element 54 and the imaging element 61 are coaxial and separate members in the present example. Thus, since the tracking light receiving element 54 and the imaging element 61 each receive sufficient light, tracking and imaging can be performed over a wider range (reachable distance), enabling highly accurate tracking and imaging even over long distances.

### Rotation and Movement of Captured Image

The above-described surveying device has its optical system fixed inside the support frame 5 and uses the scanning mirror 15 to perform scanning with light. This configuration reduces the weight of the vertical rotation mechanism, enabling a surveying device with superior responsiveness and measurement range. This configuration, however, causes a problem where the two-dimensional image rotates and moves because the reflection surface of the reflecting mirror is inclined relative to the optical axis, which causes the image reflected by the reflection surface to rotate and move, while the imaging element is fixed inside the surveying device.

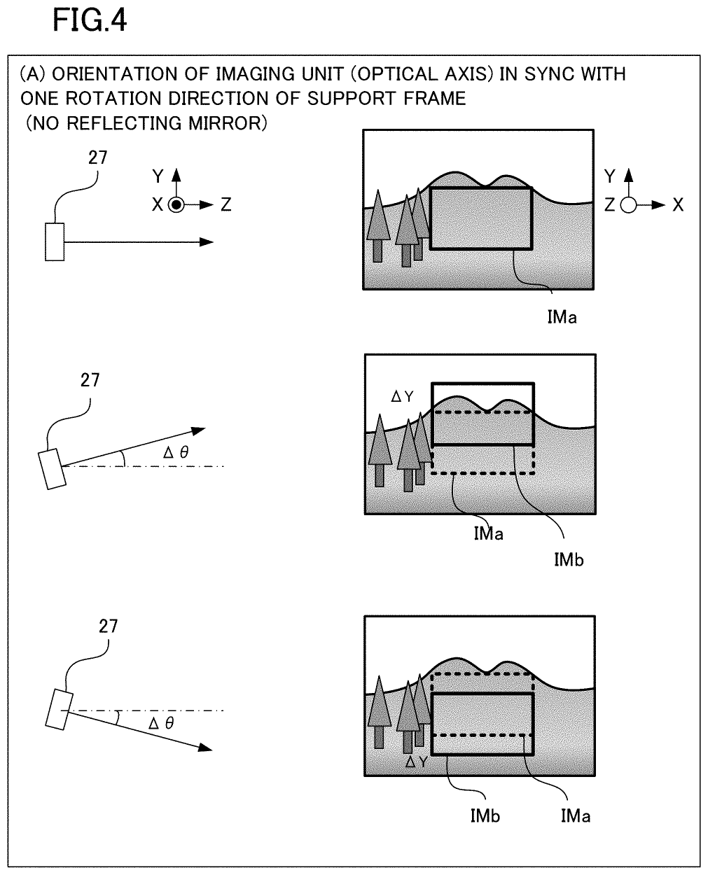

Such rotation or similar issues of the image do not occur in the imaging unit 27 when the imaging unit 27 rotates and moves in synchronization with the support frame 5 at the time of capturing an image by the surveying device 1. Specifically, as shown in FIG. 4, suppose the imaging optical axis of the imaging element 61 serving as the image sensor of the imaging unit 27 initially aligns with the Z-axis, i.e., is oriented horizontally. The area in which the image sensor can receive light is referred to as IMa.

Next, rotating the support frame 5 vertically upward (Y-direction) by θ° using the vertical rotation motor 13 causes the imaging unit 27 and its optical axis to rotate by θ° in synchronization. The region in which the image sensor can receive light transitions from IMa to IMb; however, the rotation of the image does not occur. The amount of Y-directional transition ΔY from IMa to IMb can be calculated based on the measurement of 0° by the vertical angle encoder 14 serving as an angle measuring sensor.

Similarly, when the support frame 5 rotates vertically downward by θ°, the imaging unit 27 and its optical axis also rotate downward by θ° in synchronization. The region in which the image sensor can receive light transitions from IMa to IMb, causing a displacement of ΔY. The same applies to the horizontal direction and the description is omitted.

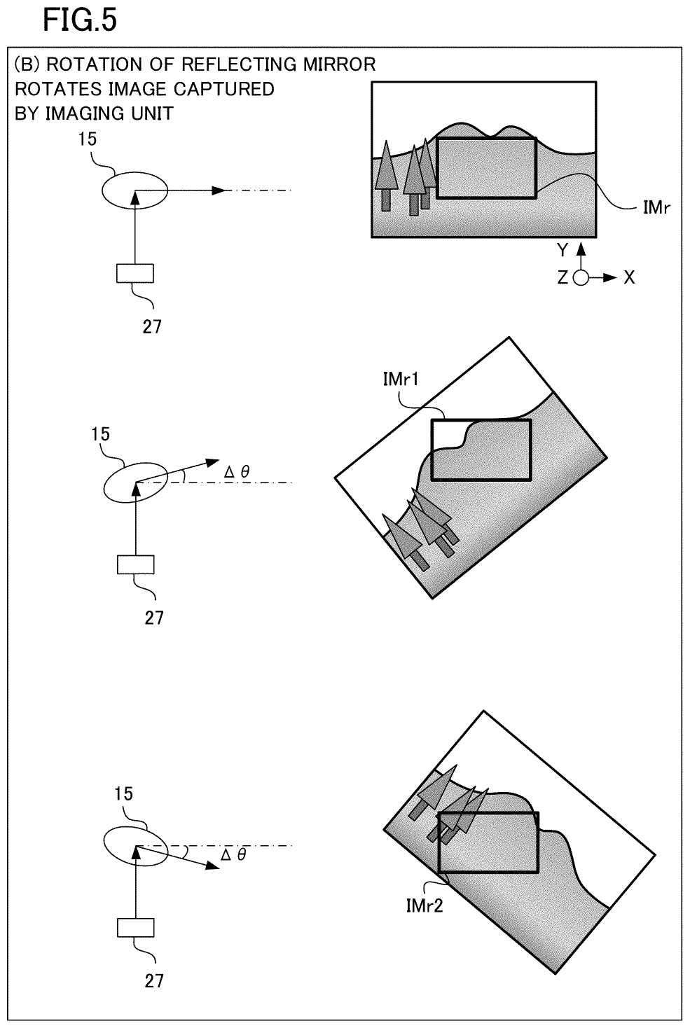

Next, the following describes a case where a reflecting mirror (scanning mirror 15) rotates about the imaging optical axis of the imaging element 61, as described in the present disclosure. FIG. 5 differs from FIG. 4 in that the imaging unit 27 is positioned in front (the figure shows the imaging unit 27 below the scanning mirror 15 for the sake of convenience), and the imaging optical axis of the imaging unit 27 is aligned with the horizontal direction through reflection by the scanning mirror 15. This state is referred to as an initial position.

As shown in FIG. 1, the scanning mirror 15 is arranged with its reflection surface inclined relative to the horizontal rotation shaft or the vertical rotation shaft of the support frame 5 (e.g., inclined at 45° as shown in FIG. 1), enabling scanning in the vertical direction through its reflection surface by rotating the vertical rotation shaft 11 (first rotation shaft). However, when the reflection surface rotates in such a case, the image received by the image sensor of the imaging unit 27 undergoes both rotation and transition in the XY direction and cannot be considered a simple tilt movement as shown in FIG. 4.

As shown in FIG. 5, at the beginning, it is assumed that the initial position has a vertical angle of 0° and a horizontal angle of 0°, and that an image of the light receivable area IMr of the image sensor can be captured. To perform scanning in the vertical direction using the optical axis of the imaging unit 27, the scanning mirror 15 needs to, for example, rotate by θ° upward about the vertical rotation shaft 11. At this time, since the reflection surface of the scanning mirror 15 also rotates, the image received by the image sensor IMr1 is rotated by θ° from the initial position and displaced in both the X and Y directions. The similar situation takes place in cases of rotating by θ° downward.

For the above reasons, the present inventors recognized the need to correct the displacement of the image in the rotation direction, vertical direction, and horizontal direction each time the scanning mirror rotates and considered a means to address this.

### Method of Obtaining Rotation Center for Calibration

### First Method

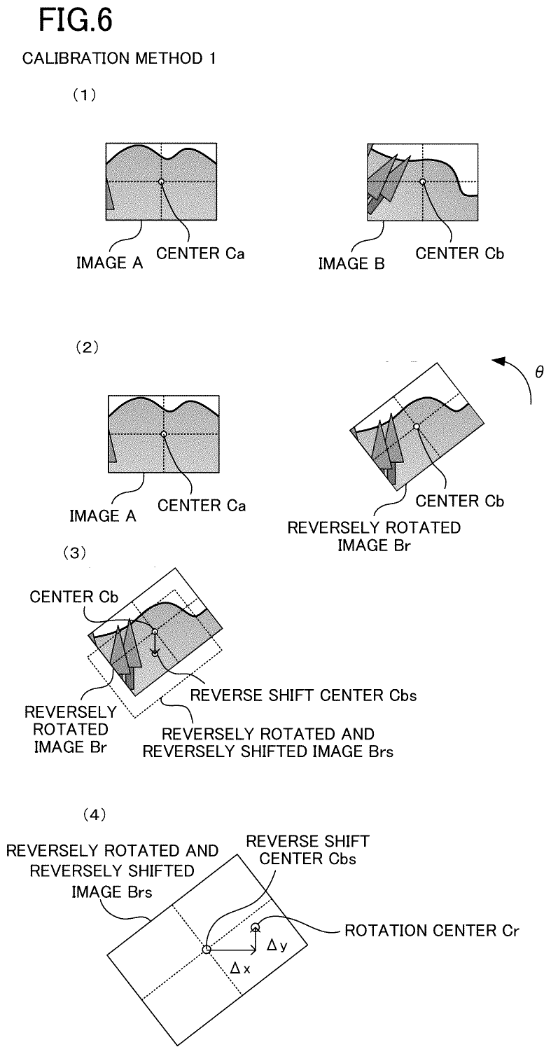

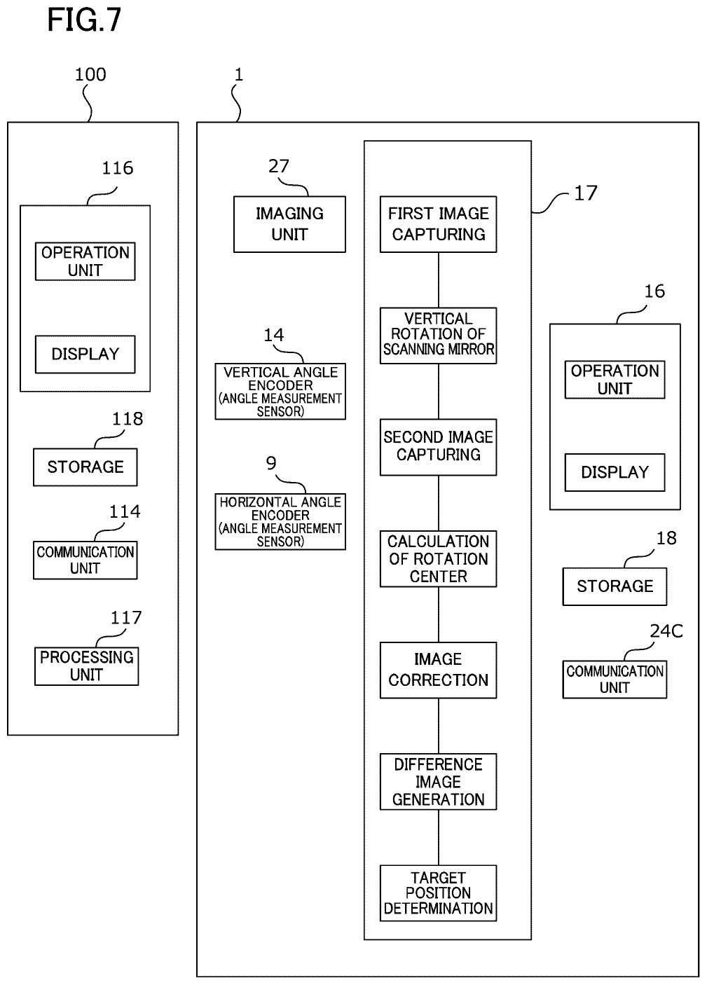

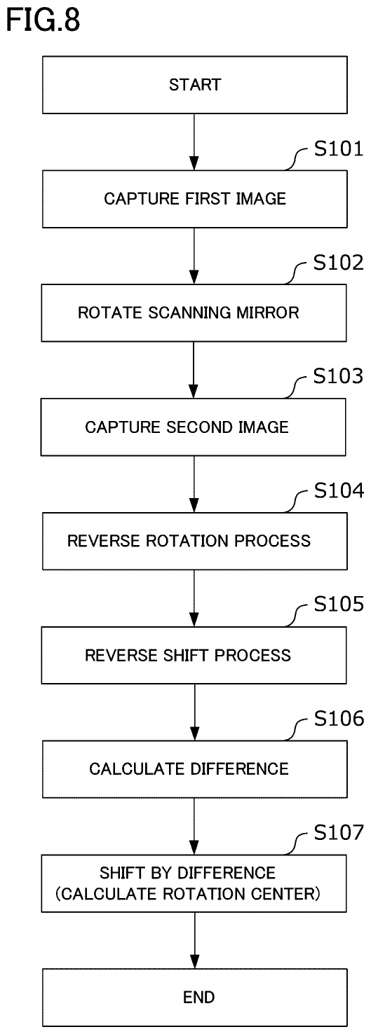

FIG. 6 is a diagram illustrating an example method of obtaining the rotation center according to the present disclosure. Further, FIG. 7 is a functional block diagram of the surveying device, and FIG. 8 is a flowchart illustrating the process flow. To correct displacement of the image, the rotation center needs to be determined. Here, an image before vertical angle rotation is referred to as image A (first image), whereas an image after vertical angle rotation is referred to as image B (second image). The image A and the image B capture different images due to vertical rotation; however, these images include a shared image region (a collection of pixels including common characteristic points). For example, in the example of FIG. 6, the ridge line of a mountain, a part of a tree, and the like are in both images and can be used as common characteristic points.

While the explanation may be out of order, the imaging unit 27 first, in step S101, captures a first image serving as a reference when the scanning mirror 15 is in a first position (first imaging). This is as described hereinabove. The first position is a reference position and is not limited to a position where the horizontal angle is 0° and the vertical angle is 0°. Further, it is sufficient to determine the relative positional relationship between the first position and a later-described second position, so the reference may be the second position.

Next, in step S102, the controller 17 rotates the scanning mirror 15 by a predetermined angle (first angle) from the first position to the second position in a rotational direction of the vertical rotation shaft (rotating). This is also as described hereinabove. Note, however, that the first angle is limited to a range so that the image A and the image B include the common feature points as the images.

Then, in step S103, the second image (image B) is captured at the second position (second imaging).

Here, the vertical rotation angles θ of the image A and the image B, caused by the vertical rotation shaft 11, are measured by the vertical angle encoder 14 (angle measuring sensor) and are therefore known. Assuming that the rotation angle is θ°, applying a reverse rotation process to the image B by an angle equivalent to θ° produces a reversely rotated image Br. Therefore, in the subsequent step S104, the controller 17 applies a reverse rotation process to the second image by the same angle as the first angle measured by the angle measuring sensor, thereby producing a reversely rotated image (reversely rotated image forming).

While the angle of the image A and the reversely rotated image Br match at this point, the images may be displaced in the horizontal direction or in the vertical direction, and the viewpoint may be shifted due to a tilt in the vertical direction.

Next, to correct the displacement of the viewpoint caused by the tilt in the vertical direction, the controller 17, in step S105, shifts the reversely rotated image by the same amount as a first shift amount corresponding to the first angle, but in the opposite direction, thereby producing a reversely rotated and reversely shifted image (reversely rotated and reversely shifted image forming). In other words, the center of the image is shifted in the opposite direction of the viewpoint shift in the vertical direction caused by vertical rotation. This is referred to as a reverse shift for convenience. This reverse shift shifts the center of the image by ΔY as a difference corresponding to the known rotation angle θ°, as described with reference to FIG. 4. For example, if producing the image B from the image A involves a vertical upward rotation, the center Cb is reversely shifted downward to obtain a reversely shifted center Cb, as shown in (3) of FIG. 6. Further, in this process, a reversely rotated and reversely shifted image Brs is produced with the reversely shifted center Cb as its center.

Next, in step S106, the controller 17 matches the first image (image A) with the reversely rotated and reversely shifted image Brs and calculates the positional difference of a characteristic point commonly included in the first image and the reversely rotated and reversely shifted image Brs (image matching). In other words, a shift amount of the position (pixel coordinates) of the common characteristic point is calculated by matching the image A with the reversely rotated and reversely shifted image Brs. In this process, a horizontal shift amount Δx and a vertical shift amount Δy are obtained as displacements of pixel coordinates, which are required for matching the common characteristic points between the image A and the reversely rotated and reversely shifted image Brs.

Next, in step S107, the controller 17 shifts the image center of the reversely rotated and reversely shifted image Brs by the positional difference of the characteristic points to obtain the rotation center coordinates of the second image with respect to the first image (rotation center calculating). That is, the position of the reversely shifted center Cb on the image is shifted based on the above-mentioned shift amount Δx and Δy. Then, the shifted position is obtained as the rotation center Cr of the image.

Obtaining such a rotation center Cr enables calibration of the surveying device by using the rotation center Cr and the known vertical rotation angle θ, even if the image is rotated as described above. Note that registering (storing in the storage 18) the rotation center Cr obtained through the above calibration method eliminates the need for calibration each time. Alternatively, various optical adjustments using the rotation center Cr may eliminate the need to register the rotation center Cr.

### Second Method

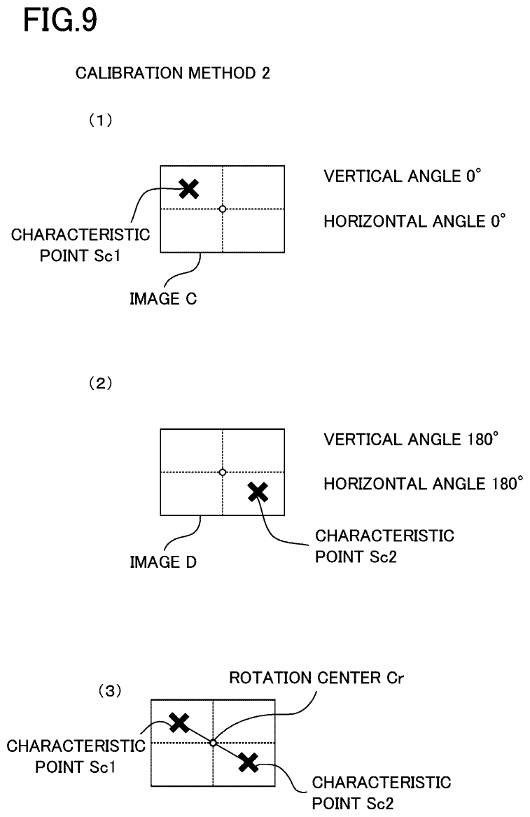

Next, a second method of obtaining the rotation center will be described. FIG. 8 is a diagram illustrating an example method of obtaining the rotation center according to the present disclosure. Further, FIG. 9 is a flowchart illustrating the process flow. Note, however, that the method described below requires a mechanism that allows 180° horizontal rotation of the support frame 5 and 180° vertical rotation of the scanning mirror 15.

First, in step S201, the imaging unit 27 captures a first image when the scanning mirror 15 is in the first position (first imaging). The first image in the second embodiment is the image C shown in FIG. 9. The image C is an image obtained with the vertical angle of 0° and the horizontal angle of 0° and contains a characteristic point Sc1.

Next, in step S202, the controller 17 rotates the scanning mirror 15 by 180° from the first position in a rotational direction of the first rotation shaft and then rotates the same by 180° to the second position in a rotational direction of the second rotation shaft (forward/reverse rotating). Next, the imaging unit 27 captures the second image at the second position (second imaging). The second image in the second embodiment is the image D shown in FIG. 9. The image D is obtained. The image D contains a characteristic point Sc2. The characteristic point Sc2 corresponds to the characteristic point Sc1.

Next, in step S203, the controller 17 connects the common characteristic points in the first image and the second image with a line segment, calculates the midpoint coordinates of the line segment, and obtains the rotation center coordinates of the second image with respect to the first image (rotation center calculating). In other words, the controller 17 overlays the image C and image D and connects the characteristic point Sc1 with the characteristic point Sc2 with a line segment. Then, the controller 17 obtains the midpoint of the line segment as the rotation center Cr of the image. The rotation center of the image can also be obtained in this way.

### Correction and Display of Rotated Captured Image

### Display of Corrected Image on Display of Surveying Device or Display of Mobile Terminal

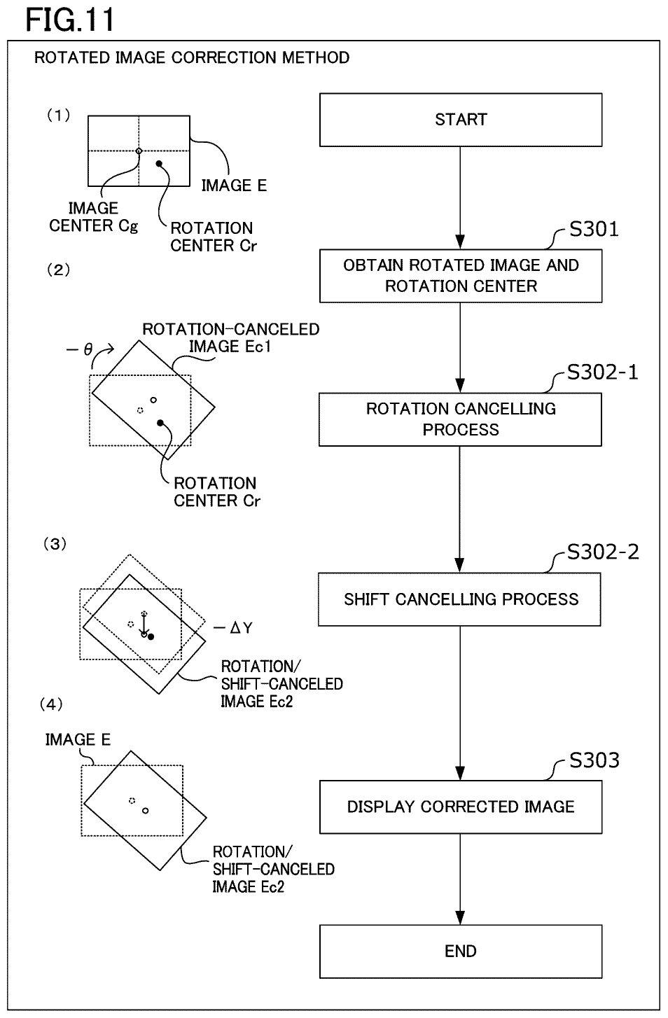

Obtaining the rotation center of the image as described above enables the correction and display of the rotated and inclined image. A flow of this process will be described with reference to FIG. 11.

First, the imaging unit 27 captures a first image (not shown) when the scanning mirror 15 is in the first position (first imaging). This first image is not subject to correction and serves as one of the reference images for the calibration method described above.

Next, the controller 17 rotates the scanning mirror 15 by the first angle (θ) in the rotational direction of the horizontal or vertical rotation axis (assumed to be vertical in this case) from the first position to the second position (rotating).

Next, the imaging unit 27 captures the second image (image E) at the second position (second imaging). This second image is an image that is rotated and has a shifted image region and requires correction. Up to this point, the process follows the same flow as the above calibration method.

Next, in step S301, the controller 17 obtains the rotation center coordinates of the second image with respect to the first image using the first image, the second image, and the first angle measured by the angle measuring sensor (rotation center calculating). This is to obtain the rotation center coordinates Cr of the second image through the above-described method, using the first image, the second image, and the angle θ corresponding to the rotational displacement from the first image to the second image by the horizontal or vertical rotation shaft.

Next, in step S302, the controller 17 generates a corrected image by using the rotation center coordinates Cr, the first angle θ, and the second image (image E) to correct the rotation and the displacement about the rotation axis (e.g., about the vertical rotation shaft) of the second image (image correcting). This is more specifically described below.

First, since the rotation angle θ and the rotation center coordinates Cr of image E have been determined through the previous process, these pieces of information are used to cancel the rotation. For example, assuming that image E has been rotated by θ°, applying a reverse rotation process of −θ° cancels the rotation. This image subjected to the reverse rotation process is referred to as rotation-canceled image Ec1.

Next, the displacement in the horizontal or vertical direction also needs to be cancelled. In this case, rotation by θ° in the vertical direction causes a transition (shift) of the captured image region by ΔY in the Y-direction (vertical direction). Therefore, a transition of the image region by −ΔY cancels the displacement in the horizontal or vertical direction, similarly to the rotation. This process of canceling the displacement of the image region in the horizontal or vertical direction is referred to as the shift cancellation process. The image obtained through the shift cancellation process applied to the above-mentioned rotation-canceled image Ec1 is referred to as the rotation/shift-canceled image Ec2. This rotation/shift-canceled image is the corrected image.

Next, in Step S303, the controller 17 displays the corrected image, instead of the second image, on the display of the surveying device 1 or the display of the mobile terminal 100 (corrected image displaying). Regarding the display, referring again to FIG. 7, the corrected image can be displayed on a display device or the like, such as the display of the surveying device 1 or the display of a mobile terminal 100, which is a general-purpose computer device capable of wireless electric communication with the surveying device 1 via a communication unit 24C or a communication unit 114. FIG. 7 shows the operation panel 16 as an example, where the display is part of the operation panel, but is not limited to this. Similarly, FIG. 7 shows a touch panel 116 as an example, where the display is part of the touch panel, but is not limited to this.

Note that the image E and the rotation/shift-canceled image Ec2 are shown with a significant angle difference for the sake of convenience in explanation. In practice, however, the angle difference is much smaller. By continuously and automatically executing this process at short intervals, a large common pixel region (i.e., an overlapping pixel region of image E and the rotation/shift-canceled image Ec2) can be obtained, thereby suppressing a drop in resolution due to the correction process.

Correcting the image in this way enables observation of the rotated image in its original orientation, thus allowing accurate tracking, even with a surveying device having a rotatable reflecting mirror on the optical axis of the imaging element.

### Automatic Collimation or Automatic Tracking of Target Light Using Corrected Image

Next, automatic collimation or automatic tracking of a target, which is an important function of the surveying device, will be described. The surveying device uses a retroreflective prism as a target to measure its position and distance to the same. This retroreflective prism is different from an optical element such as a prism used in the internal optical system and is also commonly referred to as a prism. Automatic tracking refers to continuously tracking a moving retroreflective prism to automatically measure the distance to and the angle of the measurement object. Automatic collimation refers to automatically directing a telescope or the like toward a designated target (e.g., a retroreflective prism). While automatic tracking continuously tracks a moving target, automatic collimation does not necessarily involve continuous movement and is completed once the telescope is directed toward the designated target. The technique of the present disclosure may be used in any of them.

The target may be any target as long as it can switch between a light-emitting state and a non-emitting state and is not limited to those that reflect light emitted from the light-emitting unit (e.g., a laser-emitting unit) of the surveying device via a retroreflective prism and return the light to the surveying device as reflected light. For example, a target may have a light-emitting unit, such as an LED element or a laser element, and be capable of switching between a light-emitting state and a non-emitting state.

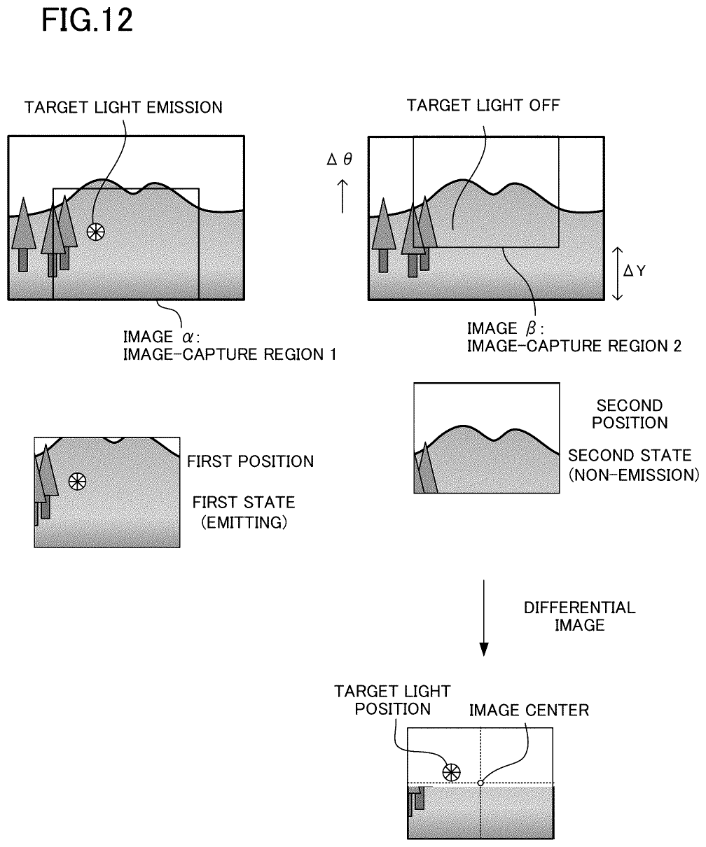

A method for determining the position of a target from an image will be described below. FIG. 12 is a schematic diagram for explaining how a target light position is determined. In this figure, an image α captures an image-capture region 1 and the target is in a first state (light-emitting state). An image β captures a state in which the rotation shaft has been rotated by θ° in the vertical direction and captures the image-capture region 2. The target does not emit light and is in a second state (non-light-emitting state) when the image β is captured. Note that when the light-emitting state is the first state, the non-light-emitting state that is a different state may be the second state, and when the non-light-emitting state is the first state, the light-emitting state that is a different state may be the second state.

When the optical axis of the surveying device (the optical axis of the telescope) is scanning in the vertical direction, the image α and the image β contain a vertical difference ΔY in their image-capture regions and a difference between the light-emitting state and the non-light-emitting state. Even if the image-capture regions of the images are different, a differential image can be obtained by shifting one image based on the rotation angle obtained by the angle measuring sensor or by adjusting the positions through image matching. This differential image, which represents the difference between an image capturing the target light in a light-emitting state and an image capturing the target light in a non-light-emitting state, allows obtaining a target light image in which the effect of ambient light or the like is canceled out. If the target light image can be obtained, the controller 17 can calculate and determine the target light position by using the difference in the pixel coordinates between the target light position and the image center position.

Further, unlike the case illustrated in the figure, when the optical axis of the surveying device is stationary and the only difference between the two images is whether the target light is present or absent, it is evident that the target light position can be determined by obtaining the difference between the two images.

However, the above-described method cannot be directly applied to a surveying device having a reflecting mirror that rotates about the optical axis of the imaging element, because the image is rotated and displaced.

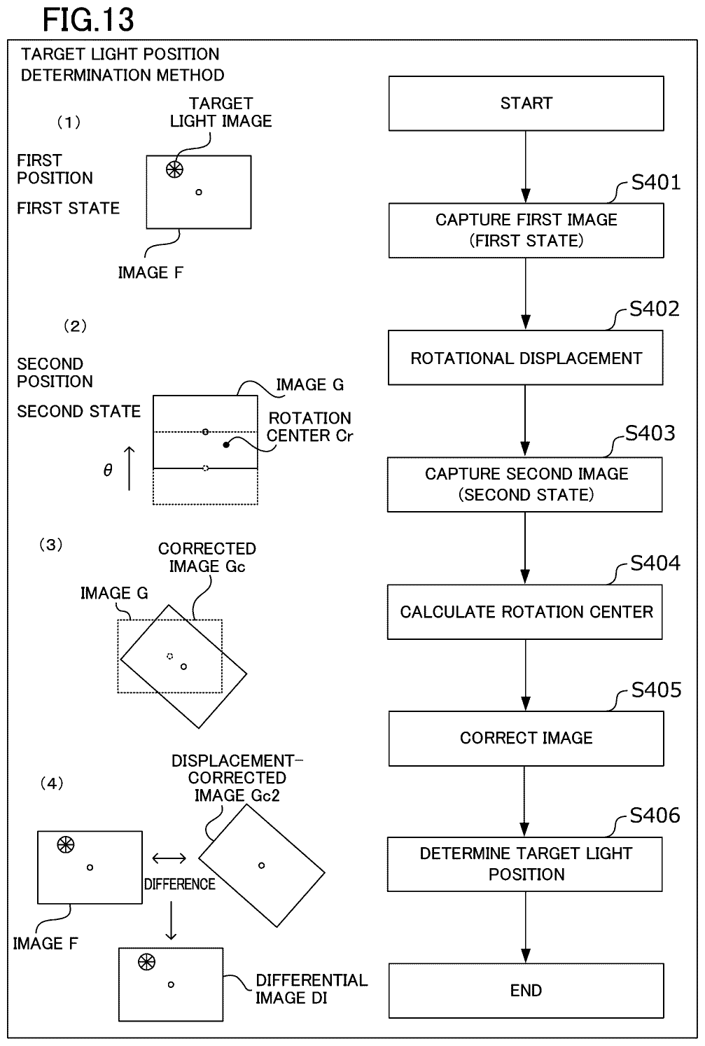

Considering the above, the method of determining the target light position will be described with reference to FIG. 13. FIG. 13 is a flowchart showing a flow of steps in a method of determining the target light position.

First, in step S401, the imaging unit 27 captures a first image (image F) while the scanning mirror 15 is in the first position and the target is in a first state of either emitting light or ceasing light emission (the light-emitting state in this case) (first imaging).

Next, in step S402, the controller 17 rotates the scanning mirror 15 by the first angle (θ) from the first position to the second position in a rotational direction of the rotation shaft (rotating).

First, in step S403, the imaging unit 27 captures a second image (image G) in the second position while the target is in a second state of either emitting light or ceasing light emission (the non-light-emitting state in this case) which is different from the first state (second imaging).

Next, in step S404, the controller 17 obtains the rotation center coordinates Cr of the second image with respect to the first image using the first image, the second image, and the first angle measured by the angle measuring sensor (rotation center calculating). This step can be omitted if the rotation center coordinates Cr are already stored in storage 18 or if the rotation has already been adjusted. The description is omitted as the process up to this point is the same as described above, except for the light-emitting or non-light-emitting state of the target light.

Next, in step S405, the controller 17 generates a corrected image Gc by using the rotation center coordinates Cr, the first angle, and the second image to correct the rotation and the displacement about the rotation axis of the second image (image correcting). The description of the method for obtaining the corrected image Gc is omitted as it is the same as the above-described image correction method.

Next, in step S406, the controller 17 obtains the differential image DI between the first image (image F) and the corrected image Gc and determines the target light position by using the differential image DI (target position determining). In the target light position determining described with reference to FIG. 12, the target light position is determined by using the differential image between the image α and the image β, which do not require image rotation to be considered. In other words, in step S406, the same method as in FIG. 12 is used to determine the target light position, except that this step uses an image in which displacement caused by rotation is corrected instead of the image G.

Technically speaking, it is not simply a matter of using the corrected image Gc instead of image G. Since image G is rotated by the vertical angle θ° with respect to image F, a differential image needs to be generated using a displacement-corrected image Gc, in which the displacement due to the rotation is also corrected. This corresponds to the image β being displaced by θ with respect to the image α in FIG. 12. The displacement-corrected image Gc2 is produced by applying a shift cancellation process for the vertical angle θ (correction of −ΔY in the image) to the corrected image Gc.

By using the image F and the image G obtained through scanning in the vertical angle direction, a differential image DI can be obtained, allowing determination of the target light position. Determining the target light position enables automatic collimation or automatic tracking of the target.

Thus, correcting the displacement caused by the rotation and movement of the captured image and determining the target light position appearing as the difference between the light-emitting image and non-light-emitting image allows accurate tracking, even with a surveying device having a rotatable reflecting mirror on the optical axis of the imaging element.

This concludes the description of the present disclosure. The new technique of the present disclosure can be implemented in various other forms, and parts of the content may be omitted, modified, or replaced without departing from the spirit of the present disclosure. The embodiments and variations described in the present disclosure are encompassed within the scope and spirit of the present disclosure and should be regarded as technique to be protected by the scope of the claims, as well as equivalents thereof.

An exemplary configuration of the present embodiment is as follows.

[1] A method of displaying a corrected image in a surveying device, using the surveying device including:
an imaging unit having an imaging element configured to capture an image;
a scanning mirror configured to rotate about a rotation shaft in one of a horizontal direction or a vertical direction, and having a flat reflection surface inclined relative to the rotation shaft;
an angle measuring sensor configured to measure a rotation angle of the rotation shaft;
a controller; and
a support frame having therein the imaging unit that is fixed inside the support frame and that does not rotate about the rotation shaft, the scanning mirror, the angle measuring sensor, and the controller,
to display the image captured by the imaging unit on a display of the surveying device or a display of a mobile terminal, the method including:
first imaging of capturing, by the imaging unit, a first image when the scanning mirror is in a first position;
rotating, by the controller, the scanning mirror by a first angle from the first position to a second position in a rotational direction of the rotation shaft;
second imaging of capturing, by the imaging unit, a second image at the second position;
image correcting of generating, by the controller, a corrected image, in which rotation of the second image and displacement about the rotation shaft are corrected, based on rotation center coordinates, the first angle, and the second image; and
corrected image displaying of displaying, by the controller, the corrected image, instead of the second image, on the display of the surveying device or the display of the mobile terminal.

[2] A surveying device, including:
an imaging unit having an imaging element configured to capture an image;
a scanning mirror configured to rotate about a rotation shaft in one of a horizontal direction or a vertical direction, and having a flat reflection surface inclined relative to the rotation shaft;
an angle measuring sensor configured to measure a rotation angle of the rotation shaft;
a controller; and
a support frame having therein the imaging unit, the scanning mirror, the angle measuring sensor, and the controller, wherein:
the imaging unit is fixed inside the support frame and does not rotate about the rotation shaft; and
to display the image captured by the imaging unit on a display of the surveying device or a display of a mobile terminal,
the imaging unit captures a first image when the scanning mirror is in a first position;
the controller rotates the scanning mirror by a first angle from the first position to a second position in a rotational direction of the rotation shaft;
the imaging unit captures a second image at the second position;
the controller generates a corrected image, in which rotation of the second image and displacement about the rotation shaft are corrected, based on rotation center coordinates, the first angle, and the second image; and
the controller displays the corrected image, instead of the second image, on the display of the surveying device or the display of the mobile terminal.

[3] A method of determining a target light position for automatic collimation or automatic tracking by a surveying device, using the surveying device including:
an imaging unit having an imaging element configured to capture an image;
a scanning mirror configured to rotate about a rotation shaft in one of a horizontal direction or a vertical direction, and having a flat reflection surface inclined relative to the rotation shaft;
an angle measuring sensor configured to measure a rotation angle of the rotation shaft;
a controller; and
a support frame having therein the imaging unit that is fixed inside the support frame and that does not rotate about the rotation shaft, the scanning mirror, the angle measuring sensor, and the controller, and using
a target capable of emitting light and ceasing light emission, the method including:
first imaging of capturing, by the imaging unit, a first image when the scanning mirror is in a first position while the target is in a first state of either emitting light or ceasing light emission;
rotating, by the controller, the scanning mirror by a first angle from the first position to a second position in a rotational direction of the rotation shaft;
second imaging of capturing, by the imaging unit, a second image in the second position while the target is in a second state which is different from the first state of either emitting light or ceasing light emission;
image correcting of generating, by the controller, a corrected image, in which rotation of the second image and displacement about the rotation shaft are corrected, based on rotation center coordinates, the first angle, and the second image; and
target position determining of, by the controller, obtaining a differential image between the first image and the corrected image and determining the target light position by using the differential image.

[4] A surveying device capable of automatic collimation or automatic tracking of a target light position, the surveying device including:
an imaging unit having an imaging element configured to capture an image;
a scanning mirror configured to rotate about a rotation shaft in one of a horizontal direction or a vertical direction, and having a flat reflection surface inclined relative to the rotation shaft;
an angle measuring sensor configured to measure a rotation angle of the rotation shaft;
a controller; and
a support frame having therein the imaging unit that is fixed inside the support frame and that does not rotate about the rotation shaft, the scanning mirror, the angle measuring sensor, and the controller, wherein:
the surveying device uses a target capable of emitting light and ceasing light emission;
the imaging unit captures a first image when the scanning mirror is in a first position while the target is in a first state of either emitting light or ceasing light emission;
the controller rotates the scanning mirror by a first angle from the first position to a second position in a rotational direction of the rotation shaft;
the imaging unit captures a second image in a second position while the target is in a second state which is different from the first state of either emitting light or ceasing light emission;
the controller generates a corrected image, in which rotation and displacement of the second image are corrected, based on rotation center coordinates, the first angle, and the second image; and
the controller obtains a differential image between the first image and the corrected image and determines the target light position by using the differential image.

What is claimed is:

1. A method of displaying a corrected image in a surveying device, using the surveying device comprising:
an imaging unit having an imaging element configured to capture an image;
a scanning mirror configured to rotate about a rotation shaft in one of a horizontal direction or a vertical direction, and having a flat reflection surface inclined relative to the rotation shaft;
an angle measuring sensor configured to measure a rotation angle of the rotation shaft;
a controller; and
a support frame having therein the imaging unit that is fixed inside the support frame and that does not rotate about the rotation shaft, the scanning mirror, the angle measuring sensor, and the controller,
to display the image captured by the imaging unit on a display of the surveying device or a display of a mobile terminal, the method comprising:
first imaging of capturing, by the imaging unit, a first image when the scanning mirror is in a first position;
rotating, by the controller, the scanning mirror by a first angle from the first position to a second position in a rotational direction of the rotation shaft;
second imaging of capturing, by the imaging unit, a second image at the second position;
image correcting of generating, by the controller, a corrected image, in which rotation of the second image and displacement about the rotation shaft are corrected, based on rotation center coordinates, the first angle, and the second image; and
corrected image displaying of displaying, by the controller, the corrected image, instead of the second image, on the display of the surveying device or the display of the mobile terminal.

2. A surveying device comprising:
an imaging unit having an imaging element configured to capture an image;
a scanning mirror configured to rotate about a rotation shaft in one of a horizontal direction or a vertical direction, and having a flat reflection surface inclined relative to the rotation shaft;
an angle measuring sensor configured to measure a rotation angle of the rotation shaft;
a controller; and
a support frame having therein the imaging unit, the scanning mirror, the angle measuring sensor, and the controller, wherein:
the imaging unit is fixed inside the support frame and does not rotate about the rotation shaft; and
to display the image captured by the imaging unit on a display of the surveying device or a display of a mobile terminal,
the imaging unit captures a first image when the scanning mirror is in a first position;
the controller rotates the scanning mirror by a first angle from the first position to a second position in a rotational direction of the rotation shaft;
the imaging unit captures a second image at the second position;
the controller generates a corrected image, in which rotation of the second image and displacement about the rotation shaft are corrected, based on rotation center coordinates, the first angle, and the second image; and
the controller displays the corrected image, instead of the second image, on the display of the surveying device or the display of the mobile terminal.

3. A method of determining a target light position for automatic collimation or automatic tracking by a surveying device, using the surveying device comprising:
an imaging unit having an imaging element configured to capture an image;
a scanning mirror configured to rotate about a rotation shaft in one of a horizontal direction or a vertical direction, and having a flat reflection surface inclined relative to the rotation shaft;
an angle measuring sensor configured to measure a rotation angle of the rotation shaft;
a controller; and
a support frame having therein the imaging unit that is fixed inside the support frame and that does not rotate about the rotation shaft, the scanning mirror, the angle measuring sensor, and the controller, and using
a target capable of emitting light and ceasing light emission, the method comprising:
first imaging of capturing, by the imaging unit, a first image when the scanning mirror is in a first position while the target is in a first state of either emitting light or ceasing light emission;
rotating, by the controller, the scanning mirror by a first angle from the first position to a second position in a rotational direction of the rotation shaft;
second imaging of capturing, by the imaging unit, a second image in the second position while the target is in a second state which is different from the first state of either emitting light or ceasing light emission;
image correcting of generating, by the controller, a corrected image, in which rotation of the second image and displacement about the rotation shaft are corrected, based on rotation center coordinates, the first angle, and the second image; and
target position determining of, by the controller, obtaining a differential image between the first image and the corrected image and determining the target light position by using the differential image.

4. A surveying device capable of automatic collimation or automatic tracking of a target light position, the surveying device comprising:
an imaging unit having an imaging element configured to capture an image;
a scanning mirror configured to rotate about a rotation shaft in one of a horizontal direction or a vertical direction, and having a flat reflection surface inclined relative to the rotation shaft;
an angle measuring sensor configured to measure a rotation angle of the rotation shaft;
a controller; and
a support frame having therein the imaging unit that is fixed inside the support frame and that does not rotate about the rotation shaft, the scanning mirror, the angle measuring sensor, and the controller, wherein:
the surveying device uses a target capable of emitting light and ceasing light emission;
the imaging unit captures a first image when the scanning mirror is in a first position while the target is in a first state of either emitting light or ceasing light emission;
the controller rotates the scanning mirror by a first angle from the first position to a second position in a rotational direction of the rotation shaft;
the imaging unit captures a second image in a second position while the target is in a second state which is different from the first state of either emitting light or ceasing light emission;
the controller generates a corrected image, in which rotation and displacement of the second image are corrected, based on rotation center coordinates, the first angle, and the second image; and
the controller obtains a differential image between the first image and the corrected image and determines the target light position by using the differential image.
